(19) United States
(12) Patent Application Publication
(10) Pub. No.: US 2025/0288400 A1
(43) Pub. Date: Sep. 18, 2025

(54) Intraoral Device for Isolation and Fluid Evacuation

(71) Applicant: Ascentcare Dental Products, Inc., Grand Haven, MI (US)

(72) Inventor: Austin R. Ritter, Grand Haven, MI (US)

(21) Appl. No.: 19/075,145

(22) Filed: Mar. 10, 2025

Related U.S. Application Data
(60) Provisional application No. 63/564,316, filed on Mar. 12, 2024.

(51) Int. Cl. A61C 17/12; A61C 17/06

(52) U.S. Cl. CPC A61C 17/12; A61C 17/084

(57) ABSTRACT

An intraoral device for dental isolation and fluid evacuation is disclosed. The device includes a first flap and a second flap positioned adjacent to the first flap to form an evacuation chamber, the second flap including a plurality of peaks and troughs forming a waveform shape at a first edge and a second edge of the second flap, the plurality of peaks and troughs forming a plurality of channels in fluid communication with the evacuation chamber; and an evacuation source connection portion including an opening that is in fluid communication with the evacuation chamber and configured to facilitate fluid evacuation when the evacuation source connection portion is attached to an external vacuum suction device, wherein an interior second flap surface is configured to touch an interior first flap surface at the plurality of troughs at least when suction is applied by the external vacuum suction device.

### CROSS-REFERENCE TO RELATED APPLICATIONS

This application claims the benefit of U.S. Provisional Application No. 63/564,316 filed Mar. 12, 2024, the entire disclosure of which is incorporated by reference.

### FIELD

The present disclosure generally relates to dental devices and, more specifically, to intraoral devices for providing fluid and aerosol evacuation, isolation, tongue, and cheek retraction.

### BACKGROUND

During dental examinations, procedures, or operations, saliva, water, and a number of other fluids are continually filling a patient's oral cavity. Excess fluid as described causes patient discomfort, contaminates a field of work, prevents a dental care provider from observing or operating, and could potentially cause aspiration of fluids into the throat or lungs of the patient.

In the past, various, conventional dental materials and equipment, such as isolation mouthpieces, fluid aspiration devices, slow speed suction ejectors, high speed suction ejectors, gauzes, cotton rolls, dry angles, or a combination of multiple materials or devices, have been used to address excess fluid within the patient's oral cavity during dental procedures. However, many of these conventional dental devices require a dental assistant to operate or need replacement multiple times, thereby interrupting a procedure, and most conventional dental devices do not consistently provide sufficient fluid control throughout the entire duration of the procedure. Other conventional dental mouthpieces collapse from vacuum forces or from pressure from the patient's tongue and palate while inside the oral cavity, causing a significant loss of suction.

There is, therefore, a need to address these and other issues with an improved system to remove these fluids and maintain a consistently dry field of work for a dental health care provider.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Embodiments of the invention are disclosed and include a dental mouthpiece that removes fluids from the intraoral cavity.

The dental mouthpiece may include a body portion comprised of anterior and posterior flaps that create one or more open evacuation chambers between the anterior and posterior flaps. The body portion may span the intraoral cavity when placed inside the patient's mouth. The body portion may include or connect to a suction connector portion formed on one end of the body portion in communication with the one or more open evacuation chambers. The dental mouthpiece may further comprise a cheek retractor portion formed at the other end of the body portion. The cheek retractor portion may also include an interior cavity in communication with the one or more open evacuation chambers of the body portion and the suction connector portion.

The embodiments described herein differ from and improve upon the prior art. According to the embodiments described herein, the one or more evacuation chambers of the dental mouthpiece may not collapse and therefore may not lose suction due to vacuum forces or pressure from the patient's tongue.

In embodiments, the anterior flap may include or form one or more raised channels to ensure consistent communication between the intraoral cavity inside the patient's mouth and the one or more evacuation chambers without blockage due to compression from the patient's tongue or mouth. As a result of this consistent communication, fluids within the patient's mouth are removed through the channels and the one or more evacuation chambers via suction. The one or more channels may be formed by forming the anterior flap in a waveform or serpentine shape such that the posterior flap includes a plurality of peaks and troughs. The height of the peaks that form the channel may increase in height nearer to an edge of the posterior flap than nearer to a horizontal center of the mouthpiece.

In other embodiments, the body portion may have raised nodules on interior surfaces of the anterior and/or posterior flaps to keep the anterior and posterior flaps from collapsing together, thereby ensuring the one or more evacuation chambers consistently evacuate fluids.

In other embodiments, the main body portion may have a thickened flap with channels cut into it to create an even flow of liquid evacuation. The thickness of the flap may allow for channels of greater depth, to evacuate more fluids.

According to embodiments of the present disclosure, a dental mouthpiece can include a first flap having an interior first flap surface and an exterior first flap surface, a second flap having an interior second flap surface and an exterior second flap surface, the second flap positioned adjacent to the first flap to form at least one evacuation chamber between the interior second flap surface and the interior first flap surface, the second flap including a plurality of peaks and troughs forming a waveform shape at a first edge and a second edge of the second flap, the plurality of peaks and troughs forming a plurality of channels into the evacuation chamber, and, an evacuation source connection portion connected to the first flap and the second flap, the evacuation source connection portion including an opening that is in communication with the evacuation chamber facilitating fluid evacuation when the evacuation source connection portion is attached to an external vacuum suction device, wherein the interior second flap surface of the second flap touches the interior first flap surface of the first flap at the plurality of troughs at least when suction is engaged by the external vacuum suction device.

In other embodiments, a dental mouthpiece can include a first flap having an interior first flap surface and an exterior first flap surface, an second flap having an interior second flap surface and an exterior second flap surface, the second flap positioned adjacent to the first flap to form an evacuation chamber between the interior second flap surface and the interior first flap surface, the second flap including a plurality of nodules formed on the interior second flap surface, the plurality of nodules forming a plurality of channels into the evacuation chamber, and an evacuation source connection portion connected to the first flap and the second flap, the evacuation source connection portion including an opening that is in communication with the evacuation chamber facilitating fluid evacuation when the evacuation source connection portion is attached to an external vacuum suction device, wherein the plurality of nodules touches the interior first flap surface of the first flap at least when suction is engaged by the external vacuum suction device.

In yet other embodiments, a dental mouthpiece can include a first flap having an interior first flap surface and an exterior first flap surface, an second flap having an interior second flap surface and an exterior second flap surface, the second flap positioned adjacent to the first flap to form an evacuation chamber between the interior second flap surface and the interior first flap surface, the second flap including having a variable thickness formed on the interior second flap surface, the variable thickness forming a plurality of channels into the evacuation chamber, and an evacuation source connection portion connected to the first flap and the second flap, the evacuation source connection portion including an opening that is in communication with the evacuation chamber facilitating fluid evacuation when the evacuation source connection portion is attached to an external vacuum suction device, wherein portions of the variable thickness touch the interior first flap surface of the first flap at least when suction is engaged by the external vacuum suction device.

Additional aspects and features of embodiments of the invention are described below and/or shown in the accompanying diagrams. Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a top view of a dental mouthpiece;

FIG. 2 is a bottom view of the dental mouthpiece shown in FIG. 1;

FIG. 3 is an isometric view of the dental mouthpiece shown in FIG. 1;

FIG. 4a is a lateral cross-sectional view of the dental mouthpiece shown in FIG. 1;

FIG. 4b is a longitudinal cross-sectional view of the dental mouthpiece shown in FIG. 1;

FIG. 5 is another top view of the dental mouthpiece shown in FIG. 1;

FIG. 6a is a side view of the dental mouthpiece shown in FIG. 1;

FIG. 6b is a cross-sectional view of the dental mouthpiece shown in FIG. 1;

FIG. 7a is a front view of the dental mouthpiece shown in FIG. 1;

FIG. 7b is a rear view of the dental mouthpiece shown in FIG. 1;

FIG. 8 is an isometric view of a second embodiment of the dental mouthpiece;

FIG. 9a is a side view of the dental mouthpiece shown in FIG. 8;

FIG. 9b is a cross-sectional view of the dental mouthpiece shown in FIG. 8;

FIG. 10a is a top view of the dental mouthpiece shown in FIG. 8;

FIG. 10b is a bottom view of the dental mouthpiece shown in FIG. 8;

FIG. 11a is a front view of the dental mouthpiece shown in FIG. 8;

FIG. 11b is a rear view of the dental mouthpiece shown in FIG. 8;

FIG. 12 is an isometric view of a third embodiment of the dental mouthpiece;

FIG. 13a is a cross-sectional view of the dental mouthpiece shown in FIG. 12;

FIG. 13b is another cross-sectional view of the dental mouthpiece shown in FIG. 12;

FIG. 14a is a top view of the dental mouthpiece shown in FIG. 12;

FIG. 14b is a front view of the dental mouthpiece shown in FIG. 12.

In the drawings, reference numbers may be reused to identify similar and/or identical elements.

### DETAILED DESCRIPTION

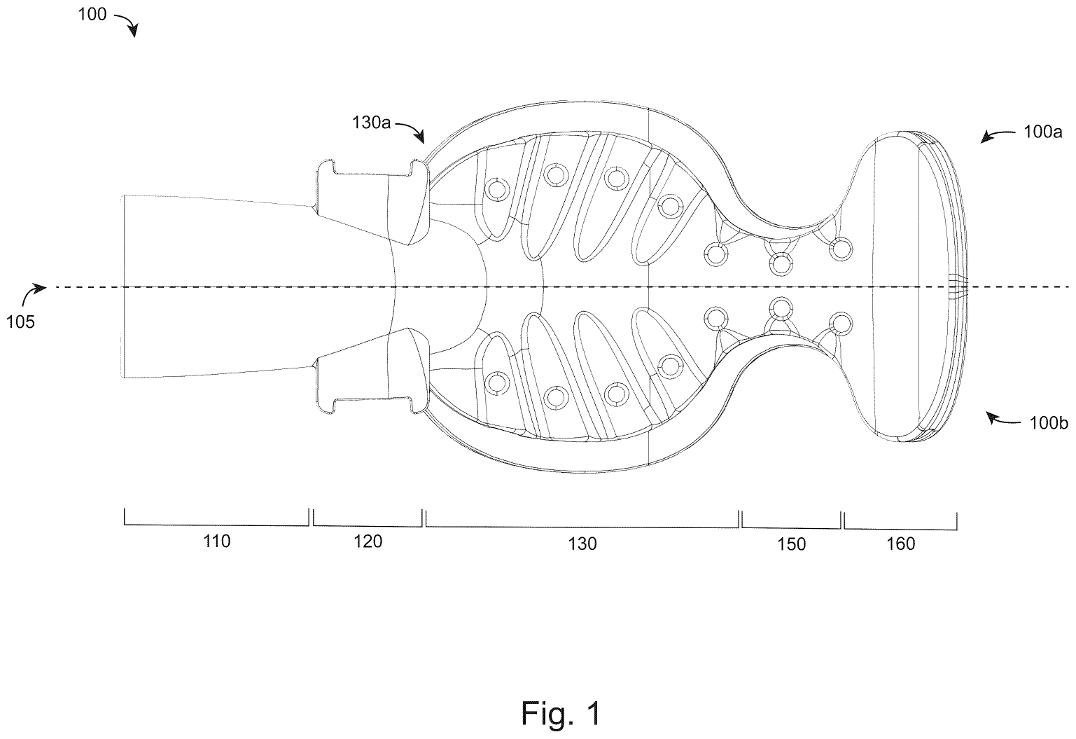

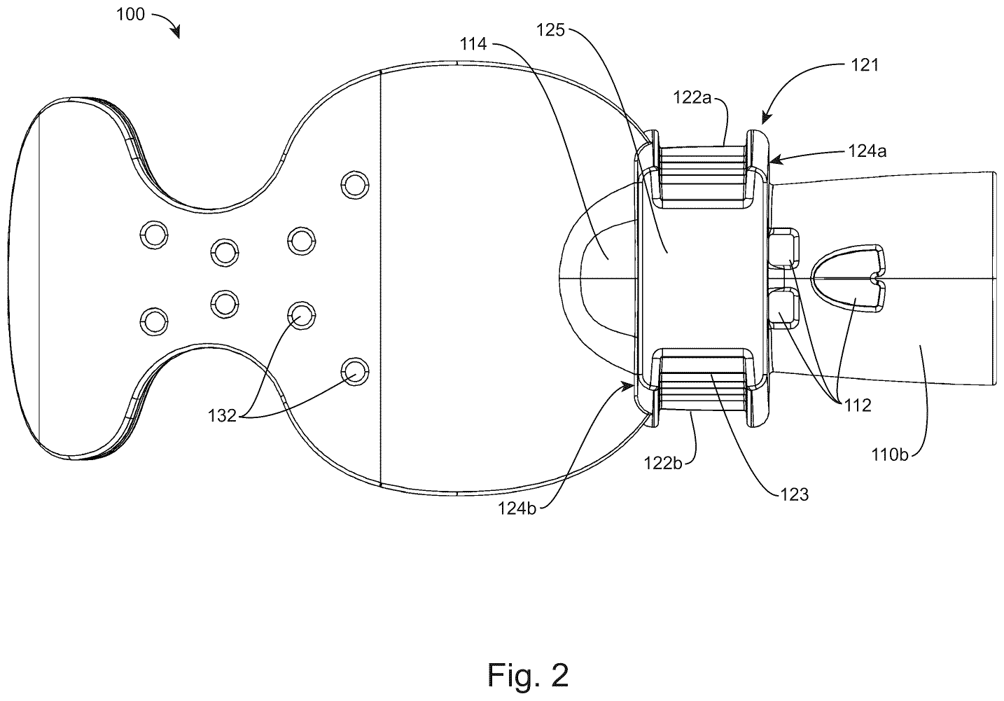

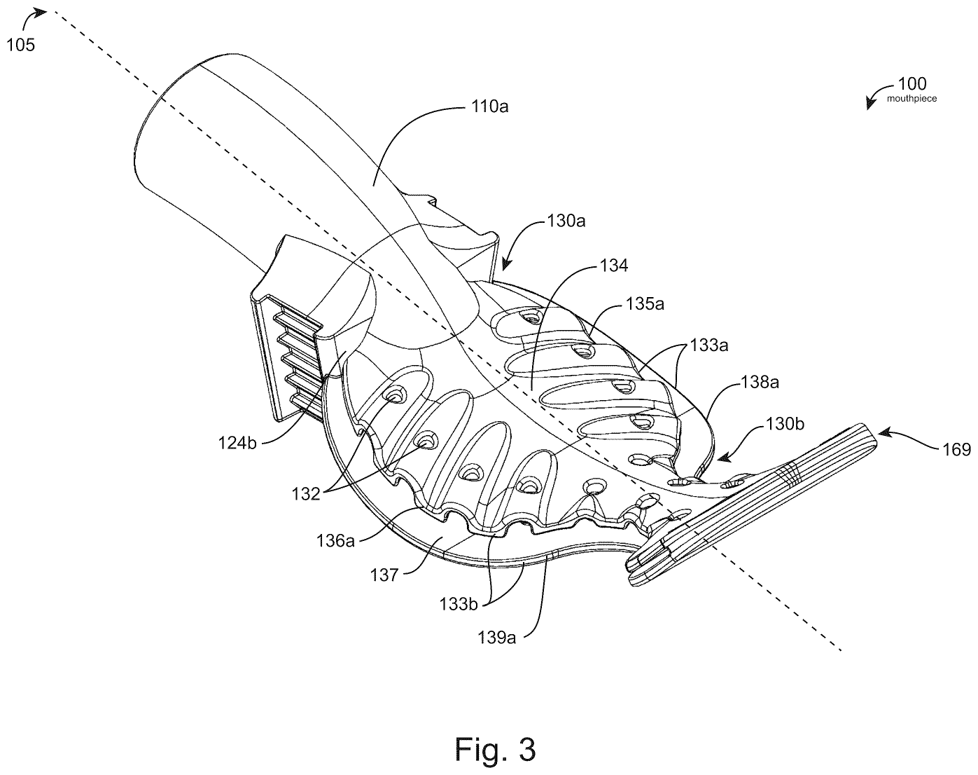

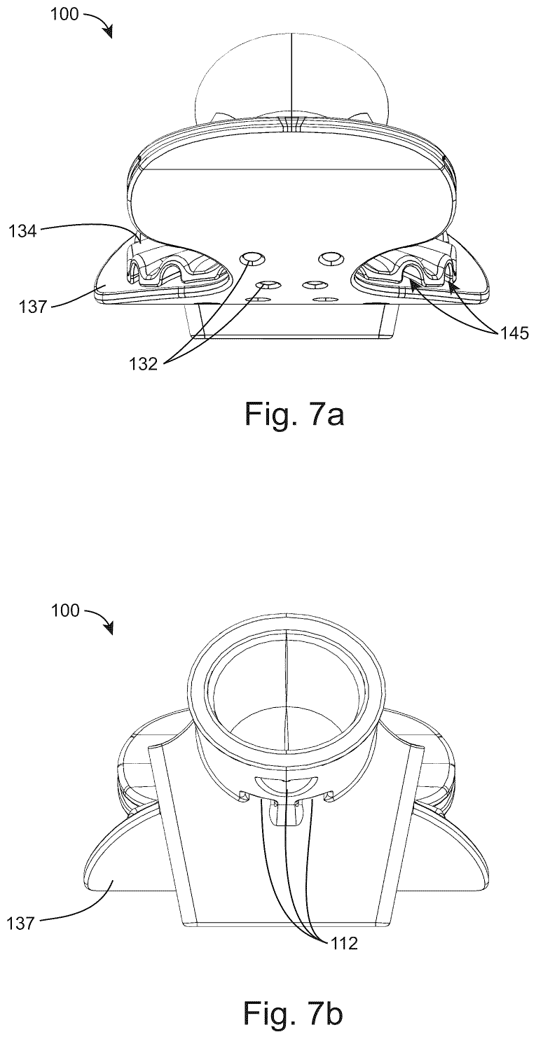

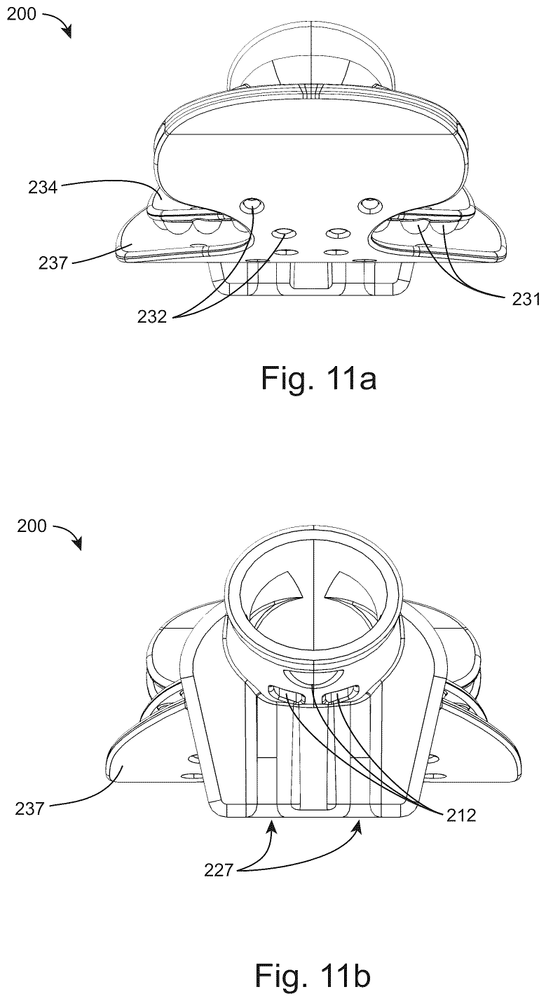

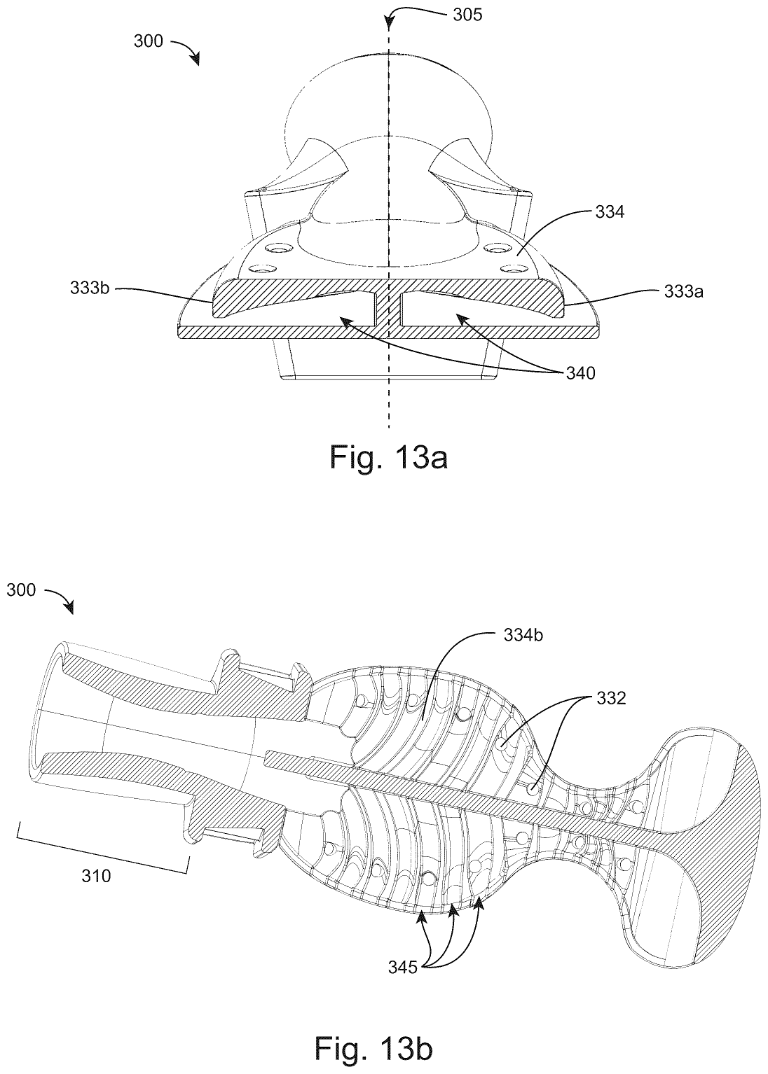

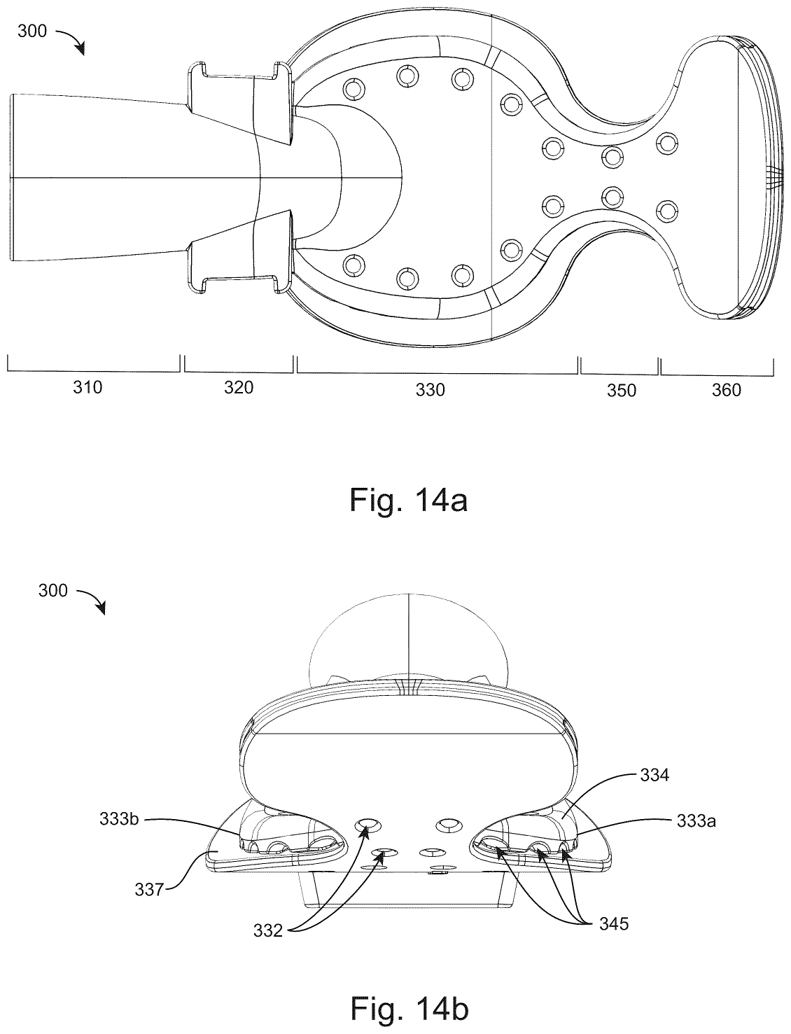

With reference to FIGS. 1-14b and described in more detail herein below, embodiments of the present invention are directed to an intraoral dental isolation mouthpiece used to aid dental professionals, such as dentists, hygienists, oral surgeons, etc. (hereinafter referred to as ‘dental professionals’), in aspirating fluids consistently from all areas of the patient's mouth to provide a dry, isolated field for optimal operating conditions, patient comfort, and safety. The intraoral dental isolation mouthpiece (hereinafter referred to as “mouthpiece”) is comprised of a body portion and an evacuation source connection portion. The mouthpiece may also be comprised of other portions in various embodiments, such as a bite block portion, evacuation adapter interlock portion and/or a cheek retractor portion, and sub-portions thereof.

When properly positioned inside the patient's mouth, the evacuation source connection portion may protrude from one side of the patient's mouth in order to be coupled to an external evacuation device. The patient may rest their teeth on one side of a patient's mouth on the bite block portion. The body portion containing the one or more evacuation chambers may span across the patient's intraoral cavity, lying against the back of the patient's mouth and thereby retracting the tongue and also serving as airway protection. An isthmus portion may sit behind the molars on the side of the patient's mouth opposite of the bite block portion and the body portion may connect the evacuation source connection portion and the cheek retractor portion, creating an isolated working area. The cheek retractor portion may apply pressure to and rest on the interior of the patient's cheek in order to retract the tissue and protect it from sharp dental instruments.

### REFERENCE NUMBERS

As used herein, the following reference numbers correspond to the following structures:
100. mouthpiece
100a. upper mouthpiece portion
100b. lower mouthpiece portion
105. horizontal center
110. evacuation source connection portion
110a. anterior side of evacuation source connection portion
110b. posterior side of evacuation source connection portion
111. opening to the evacuation chamber
112. evacuation source interlock cutouts
113. wall variation
114. extension protrusion
115a vacuum port
115b vacuum port
120. bite block portion
121. bite block
122a. upper bite block sidewall
122b. lower bite block sidewall
123. bite block treads
124a. proximal bite block edge
124b. distal bite block edge
125. posterior side of bite block
130. body portion
130a. proximal end of body portion
130b. distal end of body portion
132. apertures
133a. upper outer edges
133b. lower outer edges
134. anterior flaps of body portion
134a. exterior surface of anterior flaps of body portion
134b interior surface of anterior flaps of body portion
135. upper anterior flap
135a. upper anterior flap outer edge
136. lower anterior flap
136a. lower anterior flap outer edge
137. posterior flaps of body portion
137a. exterior surface of posterior flaps of body portion
137b. interior surface of posterior flaps of body portion
138. upper posterior flap
138a. upper posterior flap outer edge
139. lower posterior flap
139a. lower posterior flap outer edge
140. evacuation chamber
140a. upper evacuation chamber
140b. lower evacuation chamber
141. interior space of the evacuation chamber
142. interior surface of the evacuation chamber
143. connecting core
143a. core upper sidewall
143b. core lower sidewall
145. raised channels
150. isthmus portion
155. isthmus portion width
160. cheek retractor portion
164. anterior cheek retractor flaps
167. posterior cheek retractor flaps
169. distal end of the cheek retractor portion
200. second mouthpiece embodiment
210. second mouthpiece embodiment evacuation source connection portion
212. second mouthpiece embodiment interlock cutouts
213. second mouthpiece embodiment wall variation
214. second mouthpiece embodiment extension protrusion
220. second mouthpiece embodiment bite block portion
226. bite block apertures
227. bite block channels
230. second mouthpiece embodiment body portion
231. nodules
234. second mouthpiece embodiment anterior flap of the body portion
234b. second mouthpiece embodiment interior surface of the anterior flap of the body portion
235. second mouthpiece embodiment upper anterior flap
236. second mouthpiece embodiment lower anterior flap
237. second mouthpiece embodiment posterior flap
237b. second mouthpiece embodiment interior surface of the posterior flap
232. second mouthpiece embodiment apertures
240. second mouthpiece embodiment evacuation chamber
250. second mouthpiece embodiment isthmus portion
260. second mouthpiece embodiment cheek retractor portion
300. third mouthpiece embodiment
305. third mouthpiece embodiment horizontal center
310. third mouthpiece embodiment evacuation source connection portion
320. third mouthpiece embodiment bite block portion
330. third mouthpiece embodiment body portion
332. third mouthpiece embodiment apertures
333a. third mouthpiece embodiment upper anterior flap outer edge
333b third mouthpiece embodiment lower anterior flap outer edge
334. third mouthpiece embodiment anterior flap
337. third mouthpiece embodiment posterior flap
337b. third mouthpiece embodiment interior surface of the posterior flap
340. third mouthpiece embodiment evacuation chamber
345. third mouthpiece embodiment channels
350. third mouthpiece embodiment isthmus portion
360. third mouthpiece embodiment cheek retractor portion

### Mouthpiece Description

As shown in FIGS. 1-14b, embodiments of a mouthpiece 100, 200, 300 may include the following main components: an evacuation source connection portion 110, 210, 310, a bite block portion 120, 220, 320, a body portion 130, 230, 330 with one or more evacuation chambers 140, 240, 340, an isthmus portion 150, 250, 350, and a cheek retractor portion 160, 260, 360. Other embodiments may include only some of the main components, for example, one embodiment may include the evacuation source connection portion 110, 210, 310 and body portion 130, 230, 330, but not the bite block portion 120, 220, 320, isthmus portion 150, 250, 350, or cheek retractor portion 160, 260, 360, etc. Another such embodiment may include the evacuation source connection portion 110, 210, 310 and the bite block portion 120, 220, 320 but no body portion 130, 230, 330, isthmus portion 150, 250, 350 or cheek retractor portion 160, 260, 360, etc.

Such a mouthpiece 100, 200, 300 may also be vertically symmetrical so the upper portion 100a and lower portion 100b may be formed identically to allow for the evacuation source connection portion 110, 210, 310 to be positioned on either the left or right side of the patient's mouth. The mouthpiece 100, 200, 300 may also come in different sizes and shapes for different sized mouths.

The evacuation source connection portion 110, 210, 310 of the mouthpiece 100, 200, 300 may extend a distance from the proximal end 130a of the body portion 130, 230, 330. The evacuation source connection portion 110, 210, 310 may be configured to extend outside of the patient's mouth when in use, and to attach to an external vacuum evacuation device, which may be an evacuation adapter.

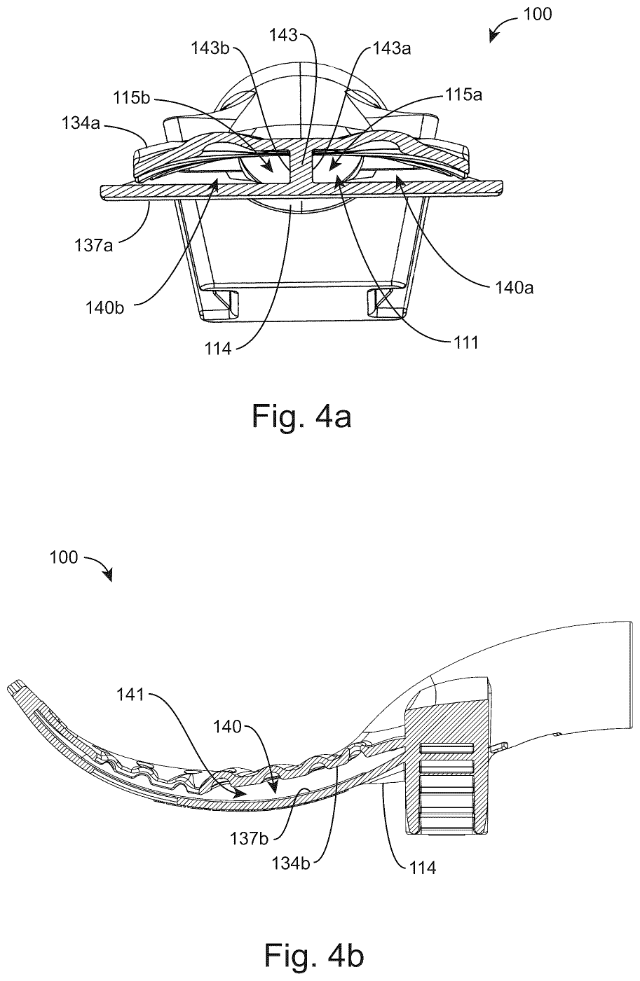

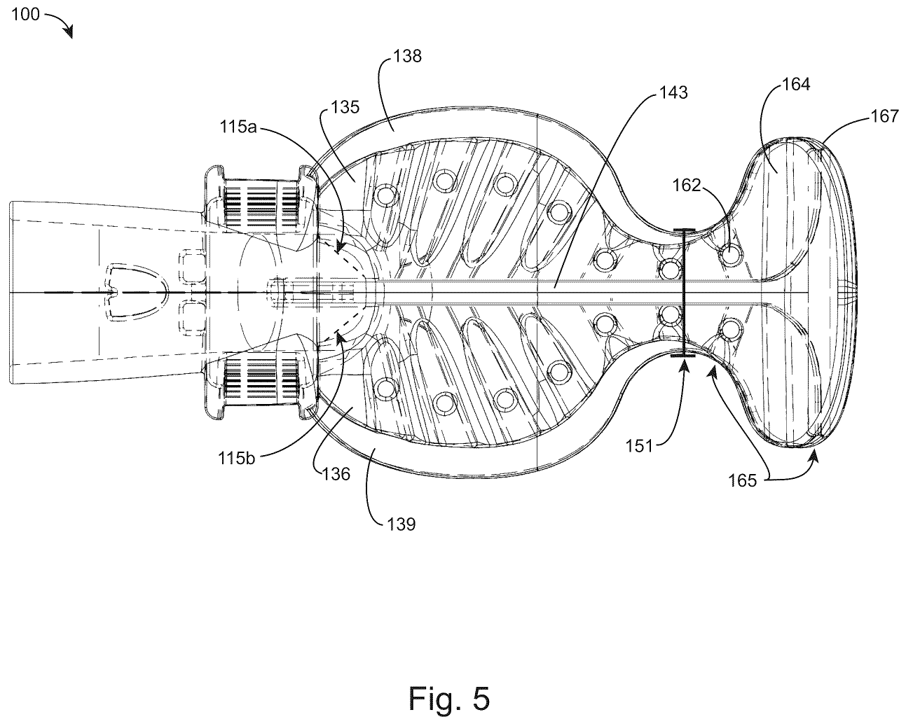

The evacuation source connection portion 110, 210, 310 of the mouthpiece 100, 200, 300 may include an opening 111 that is in communication with the interior space 141 of the one or more evacuation chambers 140, 240, 340 of the body portion 130, 230, 330 to allow for fluid evacuation when attached to an external vacuum suction device. Referring to FIGS. 4a and 5, the evacuation source connection portion 110, 210, 310 may end at one or more vacuum ports 115a, 115b, and each evacuation chamber 140, 240, 340 may begin at one of the vacuum ports 115a, 115b. As shown in FIGS. 1-14b, the mouthpiece 100, 200, 300 may include two vacuum ports 115a, 115b, each respectively associated with one of the evacuation chambers 140, 240, 340. In this way, each of the one or more vacuum ports 115a, 115b is configured to connect the opening 111 of the evacuation source connection portion 110, 210, 310 to one of the evacuation chambers 140, 240, 340. Said differently, each vacuum port 115a, 115b may be a transition point between the opening 111 and the evacuation chambers 140, 240, 340. Each vacuum port 115a, 115b may have a cross sectional surface area of at least 50 square millimeters. In some embodiments, each vacuum port 115a, 115b may have a cross-sectional area over 60 square millimeters. In some embodiments, the vacuum ports 115a, 115b may be located at points having the smallest cross-sectional area of either the opening 111 or the evacuation chambers 140, 240, 340.

The evacuation source connection portion 110, 210, 310 of the mouthpiece 100, 200, 300 may include one or more interlock cutouts 112, 212 to engage with respective protruding mouthpiece interlocks on external vacuum suction devices, including high-volume evacuation adapters. The interlock cutout or cutouts 112, 212 may be different shapes, such as a square, rectangle, triangle, circle, or other shape, and may also vary in size, allowing the mouthpiece to couple to various evacuation adapters with a corresponding protruding interlock or interlocks of similar shapes or sizes.

As shown in at least FIGS. 4a and 4b, the evacuation source connection portion 110, 210, 310 may include an extension protrusion 114 that extends from posterior flaps 137, 237, 337, resulting in a non-uniform protrusion formed on a portion of the posterior flaps 137, 237, 337 near the bite block portion 120, 220, 320 at the proximal end 130a. A channel through the evacuation source connection portion 110, 210, 310 formed by the opening 111 may extend through the bite block portion 120, 220, 320 and into a proximal end 130a of the posterior flaps 137, 237, 337. The extension protrusion 114 may ensure a sufficiently wide air channel for suction so that neither the bite block portion 120, 220, 320 nor the anterior flaps 137, 237, 337 restricts a cross-sectional surface area of the opening 111.

The evacuation source connection portion 110, 210, 310 may have a wall thickness that is thicker and/or thinner than other portions of the mouthpiece or may have varying thickness in different locations of the evacuation source connection portion 110, 210, 310 to allow for increased flexibility and elasticity in order to receive and couple with evacuation adapters of varying sizes, shapes or types. In exemplary embodiments, the evacuation source connection portion 110, 210, 310 may extend from the proximal end 130a of the body portion 130, 230, 330 at varying lengths to accommodate such differently shaped evacuation adapters.

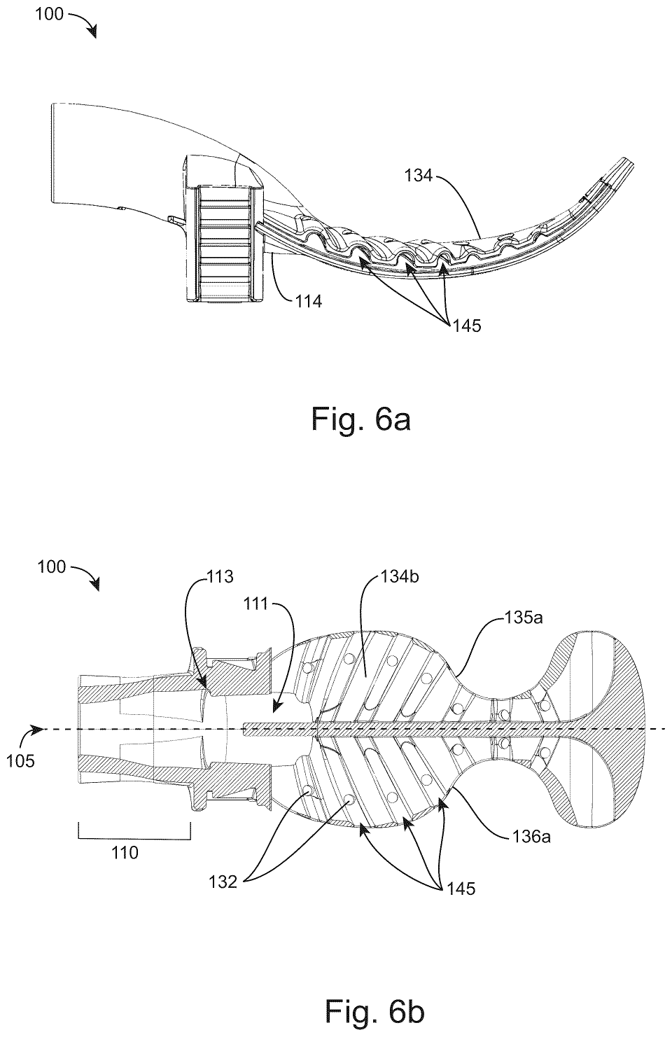

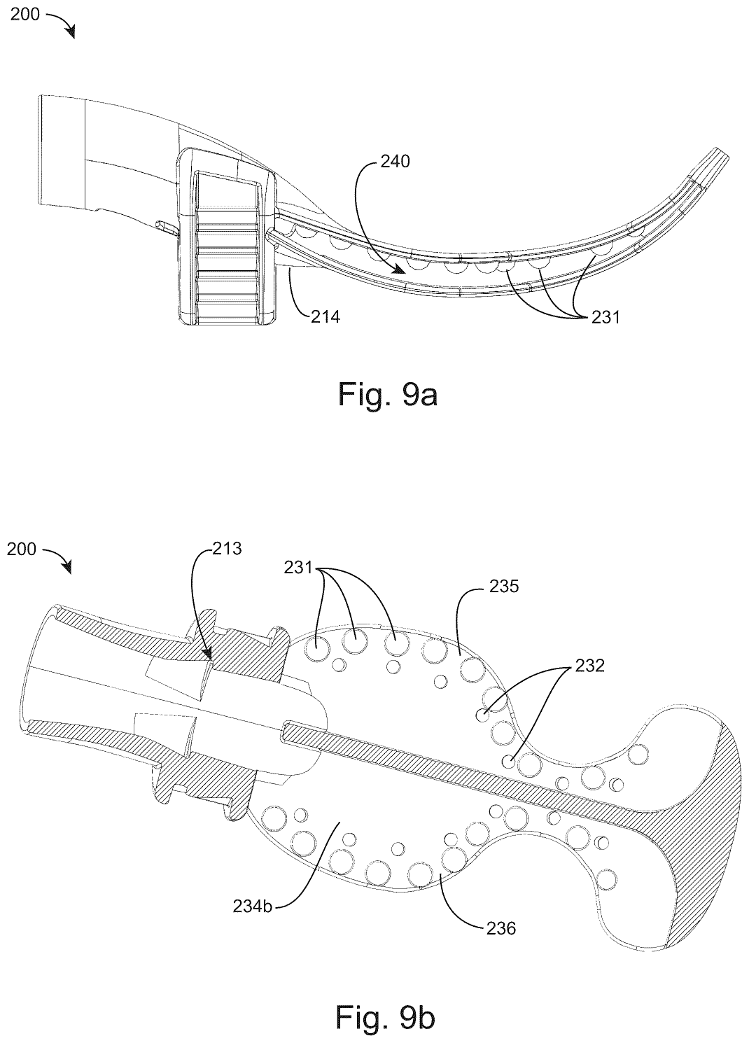

Referring now to FIGS. 6b and 9b, the evacuation source connection portion 110, 210, 310 may include a wall variation 113, 213. The wall variation 113, 213 may comprise a variation in a width of the evacuation source connection portion 110, 210, 310 at the wall variation 113, 213, and the wall variation 113, 213 may further include an increase in a width of the opening 111 through the evacuation source connection portion 110, 210, 310 at the wall variation 113, 213. The wall variation 113, 213 may taper to increase the width of the evacuation source connection portion 110, 210, 310 at the wall variation 113, 213. Alternatively, the wall variation 113, 213 may decrease the thickness of the evacuation source connection portion 110, 210, 310 to at least one of the anterior side 110a of evacuation source connection portion 110 or the posterior side 110b of evacuation source connection portion 110. The increase in the width of the opening 111 at the wall variation 113, 213 may accommodate different suction connectors by different suction connector manufacturers. In this way, the wall variation 113, 213 may act as an expansion joint or other band to allow for added flexibility to the evacuation source connection portion 110, 210, 310. The wall variation 113, 213 may taper outward from a proximal end of the evacuation source connection portion 110, 210, 310 toward the bite block portion 120 at the wall variation 113, 213.

The bite block portion 120, 220, 320 of the mouthpiece may include a bite block 121 that engages the patient's teeth to keeping the mouth propped open for access during procedures. The bite block 121 may include an upper bite block sidewall 122a and a lower bite block sidewall 122b. In some embodiments, the upper and lower sidewalls 122a,b may include bite block treads 123 to grip the patient's teeth and prevent the mouthpiece 100, 200, 300 from slipping out of the patient's mouth during procedures.

The bite block 121 may also include a proximal edge 124a and distal edge 124b, perpendicular to the upper and lower sidewalls 122a,b. The distal edge 124b of the bite block 121 may be connected to the proximal end 130a of the body portion 130, 230, 330. The evacuation source connection portion 110, 210, 310 may extend through a portion of the proximal and distal edges 124a,b of the bite block 121.

The bite block 121 may be solid in some embodiments and hollow in other embodiments. In such embodiments where the bite block is hollow, there may be one or more bite block apertures 226 or bite block channels 227 that extend from the posterior side 125 of the bite block portion 120, 220, 320 and into the evacuation source connection portion 110, 210, 310. This configuration may, for example, allow for evacuation of fluids pooling behind the bite block 121 in the patient's mouth.

The body portion 130, 230, 330 of the mouthpiece 100, 200, 300 may include one or more evacuation chambers 140, 240, 340 formed by a front (“anterior”) flap 134, 234, 334 and a rear (“posterior”) flap 137, 237, 337. The anterior flap 134, 234, 334 may connect to the anterior side 110a of the evacuation source connection portion 110, 210, 310 and the posterior flap 137, 237, 337 may connect to the distal bite block edge 124b at the proximal end 130a of the body portion 130. The anterior flap 134, 234, 334 may also connect to the block edge 124b of the bite block portion 120, 220, 320 at the proximal end 130a of the body portion 130, 230, 330 in some embodiments. The anterior flap 134, 234, 334 and posterior flap 137, 237, 337 of the body portion 130, 230, 330 may extend through the isthmus portion 150, 250, 350 and cheek retractor portion 160, 260, 360 and may connect to each other at the distal end 169 of the cheek retractor portion 160, 260, 360 in some embodiments. This configuration may, for example, allow for the extension of the one or more evacuation chambers 140, 240, 340 of the main body portion 130, 230, 330 through the isthmus portion 150, 250, 350 and into the cheek retractor portion 160, 260, 360, resulting in improved suction from all sides of the patient's mouth in the isolated working area.

Such anterior and posterior flaps 134, 234, 334, 137, 237, 337 may include outer edges 133: upper outer edges 133a, 333a along the top perimeter of the anterior or posterior flaps 134, 234, 334, 137, 237, 337, and lower outer edges 133b, 333b along the bottom perimeter of the anterior or posterior flaps 134, 234, 334, 137, 237, 337. The thickness of the anterior or posterior flaps 134, 234, 334, 137, 237, 337 may be consistent from the horizontal center 105, 305 of the mouthpiece 100, 200, 300 to the outer edges of the anterior or posterior flaps 134, 234, 334, 137, 237, 337 in some embodiments but may vary in other embodiments. Such an exemplary embodiment may have an anterior or posterior flap 134, 234, 334, 137, 237, 337 thickness at the outer edge 133 of the flaps that is greater than the thickness of the flaps at the horizontal center 105, 305 of the mouthpiece 100, 200, 300.

The upper outer edge 135a of the anterior flaps 134, 234, 334 may not be connected to the upper outer edge 138a of the posterior flaps 137, 237, 337, and the lower outer edge 136a of the anterior flaps 134, 234, 334 may not be connected to the lower outer edge 139a of the posterior flaps 137, 237, 337, so the interior space 141 of the one or more evacuation chambers 140, 240, 340 can be accessed by separating the anterior and posterior flaps 134, 234, 334, 137, 237, 337. Such configuration may, for example, allow for easier access to the interior space 141 of the one or more evacuation chambers 140, 240, 340, which assists in cleaning for sterilization and reuse of such mouthpieces when made of an autoclavable material. When in use, the mouthpiece 100, 200, 300 may partially fold inside the patient's mouth and pressure from the patient's tongue and palate press the upper posterior edge 138a towards the upper anterior edge 135a and the lower posterior edge 139a towards the lower anterior edge 136a, which may create a partial seal along the outer edges of the one or more evacuation chambers 140, 240, 340 at troughs of the anterior flaps 134, 234, 334.

The perimeter around the outer edge 133 of the anterior flaps 134, 234, 334 may be less than the perimeter around the outer edge 133 of the posterior flaps 137, 237, 337. The anterior flaps 134, 234, 334 and posterior flaps 137, 237, 337 may be different sizes and/or shapes. This configuration may, for example, result in improved dental patient comfort, improved fluid evacuation and lower vacuum induced noise, etc. In other embodiments, the perimeter of the anterior flaps 134, 234, 334 and the perimeter of the posterior flaps 137, 237, 337 may be the same and/or the shape of the anterior and posterior flaps 134, 234, 334, 137, 237, 337 may be the same. In some embodiments, the perimeter around the outer edge 133 of the anterior flaps 134, 234, 334 may be less than the perimeter around the outer edge 133 of the posterior flaps 137, 237, 337 at all locations of the body portion 130, 230, 330, and in some embodiments, the perimeter around the outer edge 133 of the anterior flaps 134, 234, 334 may be less than the perimeter around the outer edge 133 of the posterior flaps 137, 237, 337 at all locations of the body portion 130, 230, 330 and the isthmus portion 150, 250, 350.

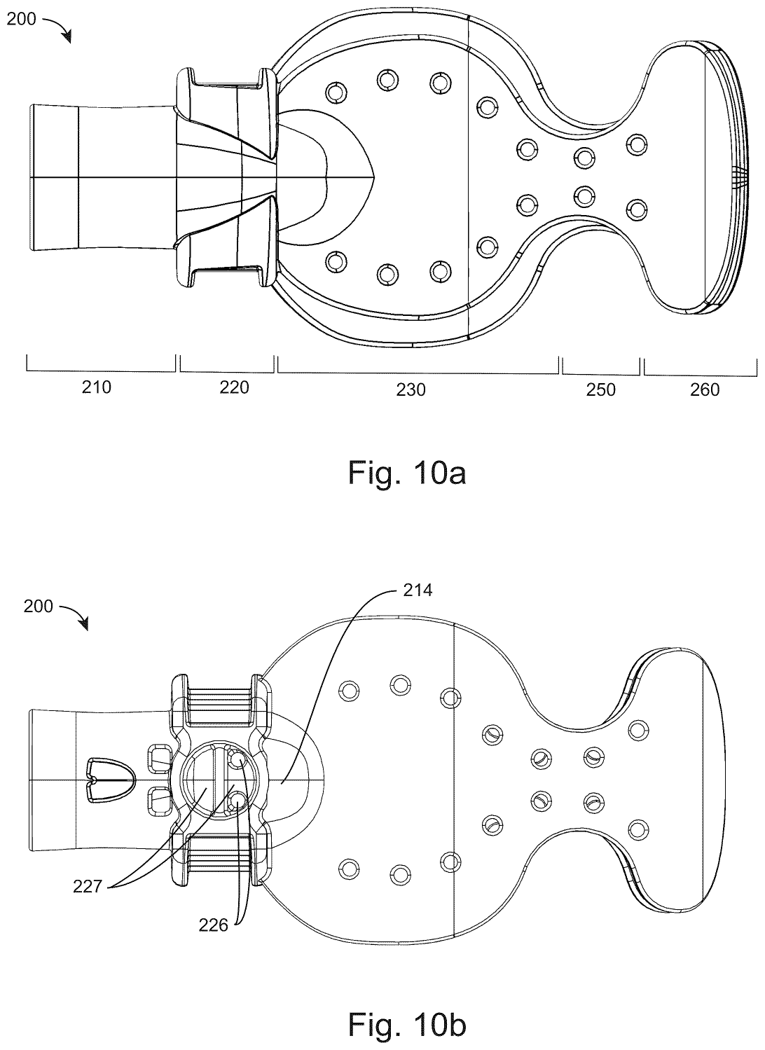

The anterior and/or posterior flaps 134, 234, 334, 137, 237, 337 may include a plurality of apertures 132, 232, 332, in communication with the interior space 141 of the one or more evacuation chambers 140, 240, 340, allowing for fluid evacuation when the mouthpiece is in use. The number of these apertures 132, 232, 332, and the placement may provide optimal evacuation based on the locations where fluids are most likely to pool inside the patient's mouth and may vary in different embodiments of the mouthpiece. In addition, apertures 132, 232, 332 formed on the anterior flaps 134, 234, 334 may be formed in different lateral positions than apertures 132, 232, 332 formed on the posterior flaps 137, 237, 337. As best shown in FIGS. 10a and 10b, which shows the anterior flaps 134, 234, 334 (FIG. 10a) and the posterior flaps 137, 237, 337 (FIG. 10b) aligned, apertures 132, 232, 332 formed on the anterior flaps 134, 234, 334 may be formed offset from the apertures 132, 232, 332 formed on the posterior flaps 134, 234, 334 (see for example, two apertures 132, 232, 332 formed in the posterior flaps 137, 237, 337 are positioned on a vertical line drawn in FIG. 10b but no apertures 132, 232, 332 formed in the posterior flaps 137, 237, 337 are positioned on the same vertical line drawn in FIG. 10a. According to exemplary embodiments, the apertures 132, 232, 332 may be positioned at a distance from the edge 133 of either the anterior flaps 134, 234, 334 or the posterior flaps 137, 237, 337, such that they are positioned in a non-linear alignment similar to an edge profile of either the anterior flaps 134, 234, 334 or the posterior flaps 137, 237, 337. The offset positioning of the apertures and the non-linear positioning of the apertures 132, 232, 332 can increase suction over the alternatives.

The anterior and posterior flaps 134, 234, 334, 137, 237, 337 may include an exterior surface 134a, 137a and an interior surface 134b, 234b, 137b, 237b, 337b and the interior surfaces 134b, 234b, 137b, 237b, 337b of both the anterior and posterior flaps 134, 234, 334, 137, 237, 337 may form the interior surfaces of the one or more evacuation chambers 140, 240, 340. The interior surfaces of the one or more evacuation chambers 140, 240, 340 (and corresponding interior surfaces 134b, 234b, 137b, 237b, 337b of the anterior and posterior flaps 134, 234, 334, 137, 237, 337) may be smooth in some embodiments. In other embodiments, one or more of the interior surfaces 134b, 234b, 137b, 237b, 337b of the posterior or anterior flaps 134, 234, 334, 137, 237, 337 may be non-planar.

The anterior flaps 134 of the first embodiment shown in FIGS. 1-7b may include a plurality of channels 145. The plurality of channels 145 may be formed by positioning the anterior flaps 134 adjacent to the posterior flaps 137, and forming the anterior flaps 134 to include a plurality of peaks and troughs forming a waveform shape at a first edge 133a and a second edge 133b of the anterior flaps 134. As best shown in FIG. 6a, the waveform shape may be formed by creating raised peaks that increase in height up to the peak height along a lateral distance of the mouthpiece and then decrease in height along the lateral distance down to each trough. The peaks may be generally rounded in shape, and the rounding extends the anterior flaps 137 upward and away from the posterior flaps 137. Each trough may be generally flat across a lateral distance between rising edges of the peaks. The width of each channel may correspond with the height of each peak, such that wider channels create taller peaks. According to an exemplary embodiment, the plurality of peaks and troughs may form the plurality of channels 145, and the channels 145 may provide channels into the one or more evacuation chambers 140. The raised channels 145 may extend towards a core 143 at different angles, as shown in FIG. 5. The alignment of the channels 145 may form a converging flow pattern towards the vacuum source. Further, the shape of each individual channel 145 may also form a converging flow. This shape and pattern may allow for air or fluid to avoid adverse pressure gradients, flow vertices and energy loss when vacuum forces are applied. According to the first embodiment, the interior anterior flaps surface 134b of the anterior flaps 134 touches the interior posterior flaps surface 137b of the posterior flaps 137 at the plurality of troughs at least when suction is engaged by the external vacuum suction device. In some embodiments, the height of the peaks that form each channel 145 may increase in height nearer to an edge 133a,b of the anterior flaps than nearer to a horizontal center 105 of the mouthpiece 100. The height of each peak forming each channel 145 may vary in height depending on location on the mouthpiece. In some embodiments, peaks formed nearer the isthmus 150 may be lower in height than peaks formed at a midsection of the body portion 130, and peaks formed nearer the bite block portion 120 may be lower in height than peaks formed at a midsection of the body portion 130.

According to the first embodiment, apertures 132 formed on the anterior flaps 137 may be formed corresponding to a position of each of the peaks or over the channels 145, as shown in at least FIGS. 1, 3 and 5, and apertures 132 formed on the posterior flaps 137 may be formed corresponding to positions of the troughs or offset from the channels 145.

The anterior and posterior flaps 134, 234, 334, 137, 237, 337 may be connected by the core 143 that extends along the horizontal center 105, 305 of the mouthpiece 100, 200, 300 most of the distance of the one or more evacuation chambers 140, 240, 340, from the first end 130a to the second end 130b of the body portion 130, 230, 330. In this regard, the core 143 may be referred to herein as the central connecting core 143. The anterior flaps 134 according to the first embodiment may be flaps above the connecting core 143 and no channels 145 may exist directly above the connecting core 143. In other words, the anterior flaps 134 omits the waveform shape along a horizontal center 105 of the dental mouthpiece 100. Such a core 143 may split the one or more evacuation chambers 140, 240, 340 into two chambers: an upper chamber 140a and a lower chamber 140b. In some embodiments, the mouthpiece 100, 200, 300 may include two anterior flaps: an upper anterior flap 135, 235 and a lower anterior flap 136, 236, and two posterior flaps: an upper posterior flap 138 and a lower posterior flap 139. This configuration may, for example, create a stiffer body portion 130, 230, 330, allowing for better retraction of the tongue and cheek.

The connecting core 143 may include an upper sidewall 143a extending between the upper anterior flap 135, 235 and the upper posterior flap 138. The connecting core 143 may include a lower sidewall 143b extending between the lower anterior flap 136, 236 and the lower posterior flap 139. A distance between the upper sidewall 143a and the lower sidewall 143b may increase along the connecting core 143 starting from the first end 130a to the second end 130b of the body portion 130, 230, 330. The core 143 may extend through the isthmus portion 150, 250, 350 and into the cheek retractor portion 160, 260, 360 in some embodiments. This configuration, for example, may stiffen the isthmus and cheek retractor portions 150, 250, 350, 160, 260, 360, allowing for improved retraction of the patient's tissue.

The height of the upper and lower sidewalls 143a,b of the core 143 may determine the distance between the anterior and posterior flaps 134, 234, 334, 137, 237, 337 at the horizontal center 105, 305 of the mouthpiece 100, 200, 300. Therefore, the core 143 may be used to separate the posterior flaps 137, 237, 337 and the anterior flaps 134, 234, 334 in order to keep the one or more evacuation chambers 140, 240, 340 open for evacuation of fluids. This configuration also may, for example, not allow the anterior and posterior flaps 134, 234, 334, 137, 237, 337 to completely compress together when vacuum forces or pressure from the patient's tongue are applied, as the area inside the one or more evacuation chambers 140, 240, 340 near the connecting core 143 may remain separated, increasing the space for airflow from the vacuum source and thus improve evacuation of fluids.

The height of the upper and lower sidewalls 143a,b of the core may vary from the proximal end 130a of the body portion 130, 230, 330 to the distal end 169 of the cheek retractor portion 160, 260, 360. In an exemplary embodiment, the height of the upper and lower sidewalls 143a,b of the core 143 may be higher at the proximal end 130a, near the evacuation source connection portion 110, 210, 310, and lower at the isthmus 150, 250, 350 and cheek retractor portion 160, 260, 360. This configuration may, for example, allow for a better fit of the isthmus portion behind the patient's molars.

The core 143 may function as a light pipe to transmit light from an optical element at the proximal end 130a of the body portion 130, 230, 330 to the second end 130b of the body portion 130, 230, 330 for illuminating the intraoral cavity. The core 143 may be designed to align with an optical element that may be integrated into an evacuation adapter when coupled to the mouthpiece 100, 200, 300.

A cross section of the upper sidewall 143a and/or the lower sidewall 143b may define a continuous curve with respect to a corresponding inner surface of the respective anterior flaps 134, 234, 334 and/or posterior flaps 137, 237, 337. Alternatively, a cross section of the upper sidewall 143a and/or the lower sidewall 143b may define a fileted curve.

The isthmus portion 150, 250, 350 may extend from the second end 130b of the body portion 130, 230, 330 connecting the body portion 130 to the cheek retractor portion 160, 260, 360, and may include an extension of the one or more evacuation chambers 140, 240, 340 that continue from the body portion 130, 230, 330 through to the cheek retractor portion 160, 260, 360. The width of the isthmus portion 150, 250, 350 may be narrower than the width of the body portion 130, 230, 330 and/or cheek retractor portion 160, 260, 360. This configuration may allow the isthmus portion 150, 250, 350 to be positioned behind the back molar in the patient's mouth without blocking the isolated working area.

The cheek retractor portion 160, 260, 360 may extend from the isthmus portion 150, 250, 350 and may be configured to apply pressure against the side of the patient's mouth opposite of the bite block portion 120, 220, 320, retracting the cheek away from the working isolated area.

Being bent inside the patient's mouth, the core 143 of the mouthpiece 100, 200, 300 may work as a spring, pushing the cheek retractor portion 160, 260, 360 against the patient's cheek, improving the retraction of the tissue. The core 143 of the mouthpiece 100, 200, 300 may fan out inside the cheek retractor portion 160, 260, 360 as in this illustrated embodiment, providing more material thickness for improved strength and retraction. Further, the material of the mouthpiece 100, 200, 300, being flexible, elastic and resilient, may also aid in the force of the retraction.

The cheek retractor portion 160, 260, 360 may be solid. In other embodiments, the cheek retractor portion 160, 260, 360 may be a partially hollow continuation of the one or more evacuation chambers 140, 240, 340, with anterior and posterior cheek retractor flaps 164, 167. In some embodiments, there may be channels 165 in the cheek retractor for fluid evacuation. In other embodiments, there may be apertures 162 in the anterior and posterior cheek retractor flaps 164, 167, or there may be a combination of channels 165 and apertures 162 in the cheek retractor flaps 164, 167.

The cheek retractor portion 160, 260, 360 may have a shape as illustrated, with rounded edges, or may be of another shape or size. The rounded edges, shape and size of the cheek retractor portion 160, 260, 360, as illustrated, may, for example, increase patient comfort and best provide protective coverage of the cheek area from sharp dental instruments without obstructing access to the work area for the dental professional.

In the illustrated embodiment in FIGS. 1-7b, a number of raised channels 145 extend from the outer edges 133 of the anterior flaps 134 towards the core 143. In such embodiment, when in use, the forces of the vacuum source, as well as forces from the patient's tongue and palate, may cause the upper and lower anterior and posterior flaps 134, 137 to press together at the troughs of the waveform shape formed by the anterior flaps 134. Such channels 145 may allow the one or more evacuation chambers 140 to remain in communication with the interior of the patient's mouth, allowing for fluids to consistently evacuate throughout the mouth without interruption in suction.

In other embodiments, the number, size, depth and position of the raised channels 145 may vary, the raised channels 145 may extend towards the core 143 at different angles, and/or the raised channels 145 may be located on the posterior flaps 137 and/or on both the anterior and posterior flaps 134, 137. In the illustrated embodiment, the raised channels 145 are aligned with the apertures 132 on the anterior flaps 134, such that the apertures 132 are formed at the plurality of peaks such that each of the first subset of the plurality of apertures are respectively in communication with one of the plurality of channels 145. In other embodiments, the apertures 132 may be located between the raised channels 145.

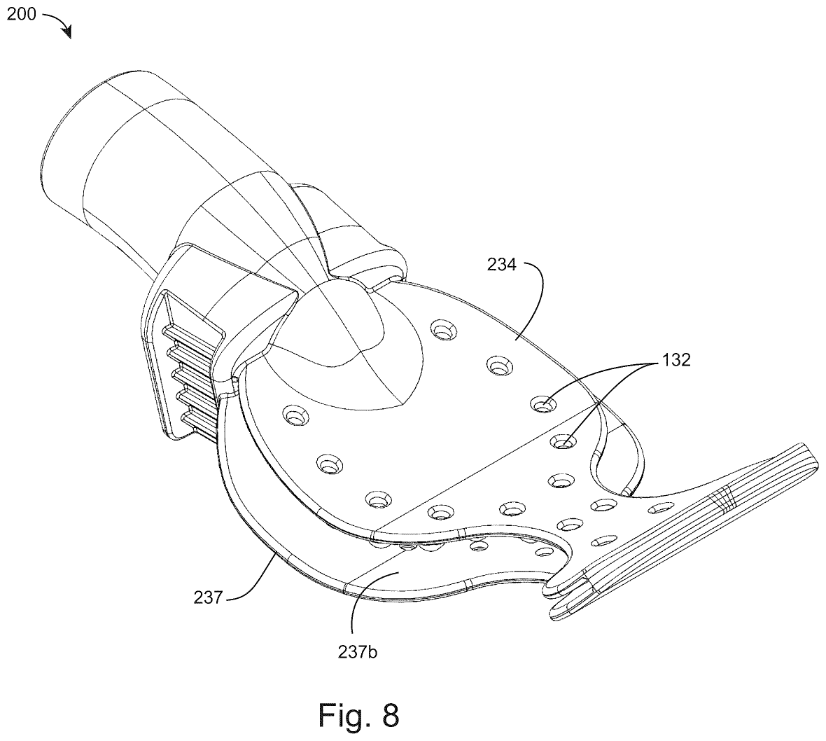

FIGS. 8-11b show views of another embodiment of the mouthpiece 200. In this illustrated embodiment, the upper and lower anterior flaps 235, 236 may include a series of nodules 231 protruding from the interior surface 2346 of the anterior flaps 234 towards the interior surface 237b of the posterior flaps 237. In other embodiments, these nodules 231 may be protruding from the interior surface 237b of the posterior flaps 237 towards the interior surface 234b of the anterior flaps 234. These nodules 231 may, for example, prevent the anterior and posterior flaps 234, 237 from collapsing together when vacuum forces and/or forces from the patient's tongue are applied, thereby allowing for continual evacuation of fluids when in use.

The nodules 231 may contact the interior surface 237b of the posterior flaps 237 and in some embodiments may be connected to the posterior flaps 237, while in others, the nodules 231 may remain detached from the posterior flaps 237. In such configurations, for example, having the nodules 231 attached to only one of the posterior or anterior flaps 234, 237, allows the mouthpiece improved flexibility to best conform to the unique shapes of individual patients' intraoral cavities.

The shape of the nodules 231 in the illustrated embodiment are semi-spherical. In other embodiments, the nodules 231 may be of a different shape. The size, location and number of nodules 231 may vary in alternative embodiments as well.

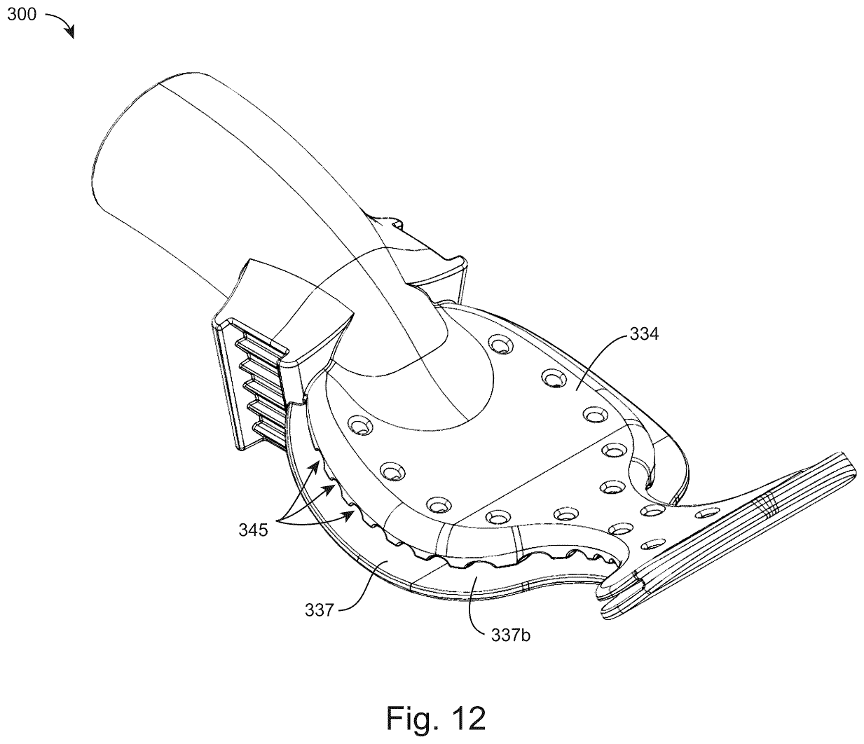

FIGS. 12-14b show views of another embodiment of the mouthpiece 300. In this illustrated embodiment, the thickness of the anterior flaps 334 increases from the horizontal center 305 of the mouthpiece 300 towards the upper and lower outer edges 333a,b, allowing for room for channels 345 of varying depth to extend from upper and lower outer edges 333a,b of the anterior flaps 334 towards the horizontal center 305 of the anterior flaps 334. Such channels 345 may decrease in depth towards the horizontal center 305 of the anterior flaps 334. This configuration may, for example, allow for improved fluid evacuation via the channels 345 when the anterior and posterior flaps 334, 337 are compressed together from vacuum forces and/or force from the patient's tongue and palate while in use. In this embodiment, the posterior flaps 337 may have a thickness that is consistent throughout, and include an interior surface 337b without channels 345.

In other embodiments, it may be the posterior flap 337 with such varying wall thickness and channels as described above, with the anterior flaps 334 having a thickness that is consistent throughout. In other embodiments, both the anterior and posterior flaps 334, 337 may have such varying wall thickness and channels as described above.

In the illustrated embodiment, the channels 345 are formed in a curve, starting at upper and lower outer edges 333a,b of the anterior flaps 334 and curving towards the evacuation source connection portion 110 at the proximal end 130a of the body portion 330. This configuration may, for example, allow for improved evacuation by directing the fluids towards the vacuum source. In other embodiments, such channels 345 may be straight, and/or may be directed at different angles. The alignment of the channels 345 may form a converging flow pattern towards the vacuum source. Further, the shape of each individual channel 345 may also form a converging flow. This shape and pattern may allow for air or fluid to avoid adverse pressure gradients, flow vertices and energy loss when vacuum forces are applied. Further embodiments may also include channels 345 of varying number, size or depth.

In some embodiments, all portions and sub-portions of the mouthpiece may be molded in one piece, preferably by injection molding. The mouthpiece is preferably molded out of a flexible, elastic, resilient and soft material. In exemplary embodiments, this material may be a high heat-resistant material, such as silicone, which allows for autoclaving and reuse. In other exemplary embodiments, this material may be a thermoplastic elastomer meant for disposal after use, preferably biocompatible. In some embodiments, this material may also be translucent and may further allow for light transfer between the ranges of 225 nm-700 nm.

The mouthpiece is comprised of a body portion and an evacuation source connection portion. The mouthpiece may also be comprised of other portions in various embodiments, such as a bite block portion, evacuation adapter interlock portion and/or a cheek retractor portion and sub-portions thereof.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The following Clauses provide an exemplary configuration for a dental mouthpiece, as described above.
Clause 1: A dental mouthpiece comprising: a first flap having an interior first flap surface and an exterior first flap surface; a second flap having an interior second flap surface and an exterior second flap surface, the second flap positioned adjacent to the first flap to form an evacuation chamber between the interior second flap surface and the interior first flap surface, the second flap including a plurality of peaks and troughs forming a waveform shape at a first edge and a second edge of the second flap, the plurality of peaks and troughs forming a plurality of channels in fluid communication with the evacuation chamber; and an evacuation source connection portion connected to at least the second flap, the evacuation source connection portion including an opening that is in fluid communication with the evacuation chamber and configured to facilitate fluid evacuation when the evacuation source connection portion is attached to an external vacuum suction device, wherein the interior second flap surface of the second flap is configured to touch the interior first flap surface of the first flap at the plurality of troughs at least when suction is applied by the external vacuum suction device.
Clause 2: The dental mouthpiece of clause 1, wherein the dental mouthpiece further comprises a third flap and a fourth flap positioned adjacent to the third flap such that the dental mouthpiece is vertically symmetrical.
Clause 3: The dental mouthpiece of any of clauses 1 through 2, wherein the evacuation source connection portion includes an interlock cutout configured to receive an adapter formed on the external vacuum suction device.
Clause 4: The dental mouthpiece of any of clauses 1 through 3 further comprising a plurality of apertures in fluid communication with the evacuation chamber and formed on the second flap, wherein a first subset of the plurality of apertures are formed at the plurality of peaks such that each of the first subset of the plurality of apertures are respectively in fluid communication with one of the plurality of channels.
Clause 5: The dental mouthpiece of any of clauses 1 through 4 further comprising a central core that extends along a horizontal center of the mouthpiece, wherein the central core connects the second flap to the first flap, and wherein the central core splits the evacuation chamber into an upper chamber and a lower chamber.
Clause 6: The dental mouthpiece of clause 5 wherein the central core further comprises a light pipe configured to transmit light from an optical element at a first end of the dental mouthpiece to a second end of the dental mouthpiece for illuminating an intraoral cavity.
Clause 7: The dental mouthpiece of any of clauses 1 through 6, wherein a cross-section of the dental mouthpiece defines a continuous filleted curve.
Clause 8: The dental mouthpiece of any of clauses 1 through 7, wherein the second flap and the first flap comprise a body portion, an isthmus portion, and a cheek retractor portion, wherein the isthmus portion extends from the body portion, wherein the cheek retractor portion extends from the isthmus portion, and wherein the isthmus portion is narrower in width than the body portion and the cheek retractor portion.
Clause 9: The dental mouthpiece of clause 8, wherein channels of the plurality of channels formed near the isthmus portion are smaller than channels of the plurality of channels formed near a midsection of the body portion.
Clause 10: The dental mouthpiece of any of clauses 1 through 9, wherein the second flap omits the waveform shape along a horizontal center of the dental mouthpiece.
Clause 11: The dental mouthpiece of any of clauses 1 through 10 further comprising a bite block having an upper bite block sidewall and a lower bite block sidewall, wherein at least one of the upper bite block sidewall or the lower bite block sidewall includes bite block treads configured to grip to a patient's teeth.
Clause 12: The dental mouthpiece of clause 11, wherein the bite block further comprises a proximal edge and a distal edge, and wherein the distal edge connects to the first flap and the second flap.
Clause 13: The dental mouthpiece of any of clauses 1 through 12, wherein a first perimeter of the second flap is smaller than a second perimeter of the first flap.
Clause 14: A dental mouthpiece comprising: a first flap having an interior first flap surface and an exterior first flap surface; a second flap having an interior second flap surface and an exterior second flap surface, the second flap positioned adjacent to the first flap to form an evacuation chamber between the interior second flap surface and the interior first flap surface, the second flap including a plurality of nodules formed on the interior second flap surface, the plurality of nodules forming a plurality of channels in fluid communication with the evacuation chamber; and an evacuation source connection portion connected to the first flap and the second flap, the evacuation source connection portion including an opening that is in fluid communication with the evacuation chamber and configured to facilitate fluid evacuation when the evacuation source connection portion is attached to an external vacuum suction device, wherein the plurality of nodules is configured to touch the interior first flap surface of the first flap at least when suction is applied by the external vacuum suction device.
Clause 15: The dental mouthpiece of clause 14, wherein the second flap and the first flap comprise a body portion, an isthmus portion, and a cheek retractor portion, wherein the isthmus portion extends from the body portion, wherein the cheek retractor portion extends from the isthmus portion, and wherein the isthmus portion is narrower in width than the body portion and the cheek retractor portion.
Clause 16: The dental mouthpiece of any of clauses 14 through 15 further comprising a plurality of apertures in fluid communication with the evacuation chamber and formed on the second flap.
Clause 17: The dental mouthpiece of any of clauses 14 through 16, wherein the dental mouthpiece further comprises a third flap and a fourth flap positioned adjacent to the third flap such that the dental mouthpiece is vertically symmetrical.
Clause 18: A dental mouthpiece comprising: a first flap having an interior first flap surface and an exterior first flap surface; a second flap having an interior second flap surface and an exterior second flap surface, the second flap positioned adjacent to the first flap to form an evacuation chamber between the interior second flap surface and the interior first flap surface, the second flap including having a variable thickness formed on the interior second flap surface, the variable thickness forming a plurality of channels in fluid communication with the evacuation chamber; and an evacuation source connection portion connected to the first flap and the second flap, the evacuation source connection portion including an opening that is in fluid communication with the evacuation chamber and configured to facilitate fluid evacuation when the evacuation source connection portion is attached to an external vacuum suction device, wherein portions of the variable thickness are configured to touch the interior first flap surface of the first flap at least when suction is applied by the external vacuum suction device.
Clause 19: The dental mouthpiece of clause 18, wherein the second flap and the first flap comprise a body portion, an isthmus portion, and a cheek retractor portion, wherein the isthmus portion extends from the body portion, wherein the cheek retractor portion extends from the isthmus portion, and wherein the isthmus portion is narrower in width than the body portion and the cheek retractor portion.
Clause 20: The dental mouthpiece of any of clauses 18 through 19 further comprising a plurality of apertures in fluid communication with the evacuation chamber and formed on the second flap.
Clause 21: A dental mouthpiece comprising: a first flap; a second flap positioned adjacent to the first flap, thereby forming an evacuation chamber between the second flap and the first flap; an evacuation source connection portion connected to at least the second flap, the evacuation source connection portion including an opening that is in fluid communication with the evacuation chamber and configured to facilitate fluid evacuation when the evacuation source connection portion is attached to an external vacuum suction device; and a vacuum port configured to connect the opening of the evacuation source connection portion to the evacuation chamber, wherein the vacuum port has a cross sectional surface area of at least 50 millimeters.

What is claimed is:

1. A dental mouthpiece comprising:
a first flap having an interior first flap surface and an exterior first flap surface;
a second flap having an interior second flap surface and an exterior second flap surface, the second flap positioned adjacent to the first flap to form an evacuation chamber between the interior second flap surface and the interior first flap surface, the second flap including a plurality of peaks and troughs forming a waveform shape at a first edge and a second edge of the second flap, the plurality of peaks and troughs forming a plurality of channels in fluid communication with the evacuation chamber; and
an evacuation source connection portion connected to at least the second flap, the evacuation source connection portion including an opening that is in fluid communication with the evacuation chamber and configured to facilitate fluid evacuation when the evacuation source connection portion is attached to an external vacuum suction device,
wherein the interior second flap surface of the second flap is configured to touch the interior first flap surface of the first flap at the plurality of troughs at least when suction is applied by the external vacuum suction device.

2. The dental mouthpiece of claim 1, wherein the dental mouthpiece further comprises a third flap and a fourth flap positioned adjacent to the third flap such that the dental mouthpiece is vertically symmetrical.

3. The dental mouthpiece of claim 1, wherein the evacuation source connection portion includes an interlock cutout configured to receive an adapter formed on the external vacuum suction device.

4. The dental mouthpiece of claim 1 further comprising a plurality of apertures in fluid communication with the evacuation chamber and formed on the second flap, wherein a first subset of the plurality of apertures are formed at the plurality of peaks such that each of the first subset of the plurality of apertures are respectively in fluid communication with one of the plurality of channels.

5. The dental mouthpiece of claim 1 further comprising a central core that extends along a horizontal center of the mouthpiece, wherein the central core connects the second flap to the first flap, and wherein the central core splits the evacuation chamber into an upper chamber and a lower chamber.

6. The dental mouthpiece of claim 5 wherein the central core further comprises a light pipe configured to transmit light from an optical element at a first end of the dental mouthpiece to a second end of the dental mouthpiece for illuminating an intraoral cavity.

7. The dental mouthpiece of claim 1, wherein a cross-section of the dental mouthpiece defines a continuous filleted curve.

8. The dental mouthpiece of claim 1, wherein the second flap and the first flap comprise a body portion, an isthmus portion, and a cheek retractor portion, wherein the isthmus portion extends from the body portion, wherein the cheek retractor portion extends from the isthmus portion, and wherein the isthmus portion is narrower in width than the body portion and the cheek retractor portion.

9. The dental mouthpiece of claim 8, wherein channels of the plurality of channels formed near the isthmus portion are smaller than channels of the plurality of channels formed near a midsection of the body portion.

10. The dental mouthpiece of claim 1, wherein the second flap omits the waveform shape along a horizontal center of the dental mouthpiece.

11. The dental mouthpiece of claim 1 further comprising a bite block having an upper bite block sidewall and a lower bite block sidewall, wherein at least one of the upper bite block sidewall or the lower bite block sidewall includes bite block treads configured to grip to a patient's teeth.

12. The dental mouthpiece of claim 11, wherein the bite block further comprises a proximal edge and a distal edge, and wherein the distal edge connects to the first flap and the second flap.

13. The dental mouthpiece of claim 1, wherein a first perimeter of the second flap is smaller than a second perimeter of the first flap.

14. A dental mouthpiece comprising:
a first flap having an interior first flap surface and an exterior first flap surface;
a second flap having an interior second flap surface and an exterior second flap surface, the second flap positioned adjacent to the first flap to form an evacuation chamber between the interior second flap surface and the interior first flap surface, the second flap including a plurality of nodules formed on the interior second flap surface, the plurality of nodules forming a plurality of channels in fluid communication with the evacuation chamber; and
an evacuation source connection portion connected to the first flap and the second flap, the evacuation source connection portion including an opening that is in fluid communication with the evacuation chamber and configured to facilitate fluid evacuation when the evacuation source connection portion is attached to an external vacuum suction device,
wherein the plurality of nodules is configured to touch the interior first flap surface of the first flap at least when suction is applied by the external vacuum suction device.

15. The dental mouthpiece of claim 14, wherein the second flap and the first flap comprise a body portion, an isthmus portion, and a cheek retractor portion, wherein the isthmus portion extends from the body portion, wherein the cheek retractor portion extends from the isthmus portion, and wherein the isthmus portion is narrower in width than the body portion and the cheek retractor portion.

16. The dental mouthpiece of claim 14 further comprising a plurality of apertures in fluid communication with the evacuation chamber and formed on the second flap.

17. The dental mouthpiece of claim 14, wherein the dental mouthpiece further comprises a third flap and a fourth flap positioned adjacent to the third flap such that the dental mouthpiece is vertically symmetrical.

18. A dental mouthpiece comprising:
a first flap having an interior first flap surface and an exterior first flap surface;
a second flap having an interior second flap surface and an exterior second flap surface, the second flap positioned adjacent to the first flap to form an evacuation chamber between the interior second flap surface and the interior first flap surface, the second flap including having a variable thickness formed on the interior second flap surface, the variable thickness forming a plurality of channels in fluid communication with the evacuation chamber; and
an evacuation source connection portion connected to the first flap and the second flap, the evacuation source connection portion including an opening that is in fluid communication with the evacuation chamber and configured to facilitate fluid evacuation when the evacuation source connection portion is attached to an external vacuum suction device,
wherein portions of the variable thickness are configured to touch the interior first flap surface of the first flap at least when suction is applied by the external vacuum suction device.

19. The dental mouthpiece of claim 18, wherein the second flap and the first flap comprise a body portion, an isthmus portion, and a cheek retractor portion, wherein the isthmus portion extends from the body portion, wherein the cheek retractor portion extends from the isthmus portion, and wherein the isthmus portion is narrower in width than the body portion and the cheek retractor portion.

20. The dental mouthpiece of claim 18 further comprising a plurality of apertures in fluid communication with the evacuation chamber and formed on the second flap.

21. A dental mouthpiece comprising:
a first flap;
a second flap positioned adjacent to the first flap, thereby forming an evacuation chamber between the second flap and the first flap;
an evacuation source connection portion connected to at least the second flap, the evacuation source connection portion including an opening that is in fluid communication with the evacuation chamber and configured to facilitate fluid evacuation when the evacuation source connection portion is attached to an external vacuum suction device; and
a vacuum port configured to connect the opening of the evacuation source connection portion to the evacuation chamber,
wherein the vacuum port has a cross sectional surface area of at least 50 millimeters.
